(19) United States
(12) Patent Application Publication
(10) Pub. No.: US 2014/0372123 A1
(43) Pub. Date: Dec. 18, 2014

(54) ELECTRONIC DEVICE AND METHOD FOR CONVERSION BETWEEN AUDIO AND TEXT

(71) Applicant: Samsung Electronics Co., Ltd., Gyeonggi-do (KR)

(72) Inventors: A-Ra Go, Gyeonggi-do (KR); Sang-Jin Kim, Gyeonggi-do (KR)

(21) Appl. No.: 14/308,516

(22) Filed: Jun. 18, 2014

(30) Foreign Application Priority Data
Jun. 18, 2013 (KR) 10-2013-0069505

(51) Int. Cl. G10L 13/027; G10L 13/04

(52) U.S. Cl. CPC G10L 13/027; G10L 13/043
USPC 704/260

(57) ABSTRACT

A method for outputting a text as audio, the method includes detecting a request for outputting a text as audio, searching for the text in a user input storage unit, searching for pronunciation data corresponding to the found text in the user input storage unit, and outputting an audio signal corresponding to the found pronunciation data. Other embodiments including an electronic device for converting audio into a text are disclosed.

### CROSS-REFERENCE TO RELATED APPLICATION AND CLAIM OF PRIORITY

The present application is related to and claims priority under 35 U.S.C. §119(a) to Korean Patent Application Serial No. 10-2013-0069505, which was filed in the Korean Intellectual Property Office on Jun. 18, 2013, the entire disclosure of which is hereby incorporated by reference.

### TECHNICAL FIELD

The present disclosure generally relates to Text To Speech (TTS), and more particularly, to a method and electronic device for conversion between audio and text.

### BACKGROUND

Recently, a TTS technique has been often adopted for multilingual terminals. TTS, “Text To Speech”, refers to conversion of a text into audio. For Japanese, Hiragana and Katakana may be easily pronounced, but Chinese characters need to be pronounced after searching for corresponding pronunciations in a Chinese character (Kanji) dictionary. A Chinese character has a different pronunciation according to a context, such that a pronunciation of a proper noun such as a person's name or a business name is different from that of a Chinese character based on a general context.

Conventional TTS searches for a Japanese Kanji (Chinese character) in a Japanese Kanji dictionary to pronounce the Japanese Kanji. A Chinese character is pronounced as a proper value stored corresponding to a context in a Chinese character dictionary, but for a Chinese character, such as a person's name or a business name, which does not have a general meaning, a conventional technique outputs a pronunciation that is different from a user's intention.

For example, when used in a person's name, “ [symbol] ”, one of Japanese Kanjis, may be pronounced variously, for example, as “ [symbol] (hikari)” or “ [symbol] (hikaru)”. Only a person using that name may know such a pronunciation, such that when a user stores that name in a contact list (or an address book), the user stores the Chinese character “ [symbol] ” through input of a pronunciation such as [symbol] or hikari, but Japanese TTS may not know whether the input [symbol] should be pronounced as “ [symbol] (hikari)” or as “ [symbol] (hikaru)”.

In this case, “ [symbol] ” may be pronounced as a representative pronunciation in the Chinese character dictionary, “ [symbol] (hikaru)”, resulting in an error.

The above information is presented as background information only to assist with an understanding of the present disclosure. No determination has been made, and no assertion is made, as to whether any of the above might be applicable as prior art with regard to the present disclosure.

### SUMMARY

To address the above-discussed deficiencies, it is a primary object to provide a method in which when a text is converted into audio or audio is converted into a text, a text having a plurality of pronunciations may be accurately pronounced according to a user's intention or the text may be accurately searched for based on a pronunciation corresponding to the user's intention.

The present disclosure also provides a method for accurately pronouncing or recognizing a Japanese Kanji, especially, a Chinese character related to a proper noun.

Various aspects of the present disclosure also provide a branching device for a hybrid cable, which facilitates a maintaining or repairing operation.

Other objects to be provided in the present disclosure may be understood by embodiments described below.

According to an aspect of the present disclosure, there is provided a method for converting a text into audio, the method including sensing a request for outputting a text as audio, searching for the text in a user input storage unit, searching for pronunciation data corresponding to the found text in the user input storage unit, and outputting an audio signal corresponding to the found pronunciation data.

According to another aspect of the present disclosure, there is provided an electronic device for converting a text into audio, the electronic device including a storage unit including a user input storage unit and a controller for identifying an event that requires output of a text as audio, searching for pronunciation data corresponding to the text in the user input storage unit, and outputting the pronunciation data found in the user input storage unit as audio if the pronunciation data corresponding to the text exists in the user input storage unit.

According to another aspect of the present disclosure, there is provided an electronic device for converting audio into a text, the electronic device including a storage unit including a user input storage unit and a controller for converting audio into pronunciation data, searching for a text mapped to the pronunciation data in the user input storage unit, and outputting the text found in the user input storage unit if the text exists in the user input storage unit.

Other aspects, advantages, and salient features of the disclosure will become apparent to those skilled in the art from the following detailed description, which, taken in conjunction with the annexed drawings, discloses an exemplary embodiment of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic block diagram of an electronic device according to an embodiment of the present disclosure;

FIG. 2 is a front perspective view of an electronic device according to an embodiment of the present disclosure;

FIG. 3 is a rear perspective view of an electronic device according to an embodiment of the present disclosure;

FIG. 4 is a diagram illustrating main components of an electronic device for executing a pronunciation information storing method according to an embodiment of the present disclosure;

FIG. 5 is a flowchart of a pronunciation information storing method according to an embodiment of the present disclosure;

FIGS. 6A to 6B are views for describing a pronunciation information storing method according to an embodiment of the present disclosure;

FIGS. 7A to 7B are views for describing another pronunciation information storing method according to an embodiment of the present disclosure;

FIGS. 8A to 8B are views for describing yet another pronunciation information storing method according to an embodiment of the present disclosure;

FIGS. 9A to 9B are views for describing yet another pronunciation information storing method according to an embodiment of the present disclosure;

FIG. 10 is a flowchart of a method for conversion between audio and text according to a first embodiment of the present disclosure;

FIG. 11 is a diagram for describing a method for conversion between audio and text according to a first embodiment of the present disclosure;

FIG. 12 is a flowchart of a method for conversion between audio and text according to a second embodiment of the present disclosure;

FIGS. 13A and 13B are diagram for describing a method for conversion between audio and text according to a second embodiment of the present disclosure; and

FIG. 14 is a diagram illustrating a calling screen.

Throughout the drawings, like reference numerals will be understood to refer to like parts, components, and structures.

### DETAILED DESCRIPTION

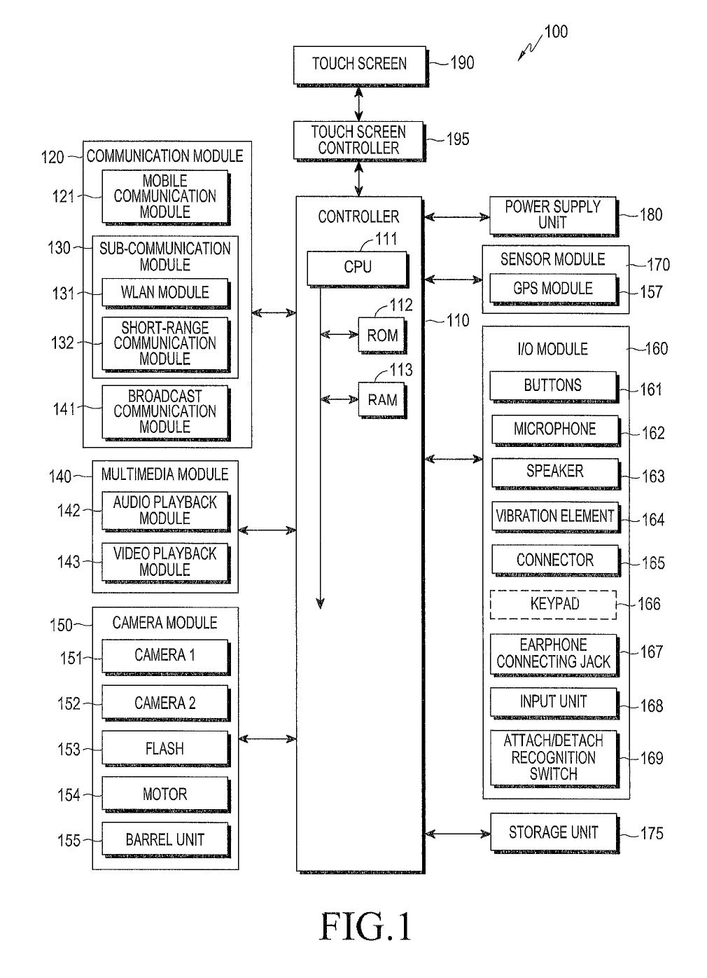

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices. As the present disclosure allows for various changes and numerous embodiments, particular embodiments will be illustrated in the drawings and described in detail. However, the present disclosure is not limited to the specific embodiments and should be construed as including all changes, equivalents, and substitutions included in the spirit and scope of the present disclosure.

Although ordinal numbers such as “first”, “second”, and so forth will be used to describe various components, those components are not limited by the terms. The terms are used only for distinguishing one component from another component. For example, a first component may be referred to as a second component and likewise, a second component may also be referred to as a first component, without departing from the teaching of the inventive concept. The term “and/or” used herein includes any and all combinations of one or more of the associated listed items.

The terminology used herein is for the purpose of describing embodiments only and is not intended to be limiting. As used herein, the singular forms are intended to include plural forms as well, unless the context clearly indicates otherwise. It will be further understood that the terms “comprises” and/or “has” when used in this specification, specify the presence of stated feature, number, step, operation, component, element, or a combination thereof but do not preclude the presence or addition of one or more other features, numbers, steps, operations, components, elements, or combinations thereof.

The terms used herein, including technical and scientific terms, have the same meanings as terms that are generally understood by those skilled in the art, as long as the terms are not differently defined. It should be understood that terms defined in a generally-used dictionary have meanings coinciding with those of terms in the related technology. As long as the terms are not defined obviously, they are not ideally or excessively analyzed as formal meanings.

In the present disclosure, an electronic device can be an arbitrary device, and the electronic device can be referred to as a portable terminal, a mobile terminal, a portable communication terminal, or a portable mobile terminal.

For example, the electronic device can be a smart phone, a cellular phone, a game console, a Television (TV), a display device, a vehicle head unit, a notebook computer, a laptop computer, a tablet computer, a Personal Media Player (PMP), a Personal Digital Assistant (PDA), or the like. The electronic device can be implemented as a pocket-size portable communication terminal having a wireless communication function. Also, the electronic device can be a flexible device or a flexible display device.

A representative structure of the electronic device is related to a cellular phone, and some components of the representative structure of the electronic device may be omitted or changed if necessary.

FIG. 1 is a schematic bloc diagram of an electronic device 100 according to an embodiment of the present disclosure.

Referring to FIG. 1, the electronic device 100 can be connected with an external device (not illustrated) by using at least one of a communication module 120, a connector 165, and an earphone connecting jack 167. The external device can include one of various devices which are removable from the electronic device 100 and are connectible with the electronic device 100 in a wired manner, such as, for example, an earphone, an external speaker, a Universal Serial Bus (USB) memory, a charging device, a cradle/dock, a Digital Multimedia Broadcasting (DMB) antenna, a mobile payment-related device, a health management device (a blood pressure monitor or the like), a game console, a vehicle navigation device, and so forth. The external device can include a wirelessly connectible Bluetooth communication device, a Near Field Communication (NFC) device, a WiFi Direct communication device, and a wireless Access Point (AP). The electronic device 100 can be connected with another portable terminal or electronic device such as, for example, one of a cellular phone, a smart phone, a tablet Personal Computer (PC), a desktop PC, and a server, in a wired or wireless manner.

Referring to FIG. 1, the electronic device 100 includes at least one touch screen 190 and at least one touch screen controller 195. The electronic device 100 also includes a controller 110, the communication module 120, a multimedia module 140, a camera module 150, an input/output module 160, a sensor module 170, a storage unit 175, and a power supply unit 180.

The communication module 120 includes a mobile communication module 121, a sub communication module 130, and a broadcast communication module 141.

The sub communication module 130 includes at least one of a Wireless Local Area Network (WLAN) module 131 and a short-range communication module 132. The multimedia module 140 includes at least one of an audio playback module 142 and a video playback module 143. The camera module 150 includes a first camera 151 and a second camera 152. In addition, depending on the primary usage of the electronic device 100, the camera module 150 of the electronic device 100, according to the present disclosure, includes at least one of a barrel unit 155 for zoom-in/zoom-out operations of the first camera 151 and the second camera 152, a motor 154 for controlling zoom-in/zoom-out motion of the barrel unit 155, and a flash 153 for providing a light source for photographing. The input/output module 160 includes button 161, a microphone 162, a speaker 163, a vibration element 164, a connector 165, and a keypad 166.

The controller 110 includes a Read Only Memory (ROM) 112 in which a control program for controlling the electronic device 100 is stored, and a Random Access Memory (RAM) 113 which memorizes a signal or data input from the electronic device 100 or is used as a memory region for a task performed in the electronic device 100. A Central Processing Unit (CPU) 111 can include a single core, a dual core, a triple core, or a quad core processor. The CPU 111, the ROM 112, and the RAM 113 can be interconnected through an internal bus.

The controller 110 controls the communication module 120, the multimedia module 140, the camera module 150, the input/output module 160, the sensor module 170, the storage unit 175, the power supply unit 180, the touch screen 190, and the touch screen controller 195.

The controller 110 senses a user input generated when a touchable user input means, such as an input unit 168, the user's finger, or the like touches one of a plurality of objects or items displayed on the touch screen 190, approaches the object, or is disposed in proximity to the object. The controller 110 also identifies the object corresponding to the position on the touch screen 190 where the user input is sensed. The user input generated through the touch screen 190 includes one of a direct touch input for directly touching an object and a hovering input, which is an indirect touch input in which the object is approached within a preset recognizing distance but not directly touched. For example, when the input unit 168 is positioned close to the touch screen 190, an object positioned immediately under the input unit 168 can be selected. In the present disclosure, the user input can include a gesture input generated through the camera module 150, a switch/button input generated through the at least one button 161 or the keypad 166, and a voice input generated through the microphone 162 as well as the user input generated through the touch screen 190.

The object or item (or functional item) is displayed on the touch screen 190 of the electronic device 100, and indicates at least one of, for example, an application, a menu, a document, a widget, a picture, a moving image, an e-mail, an SMS message, and an MMS message. The object or item (or functional item) can be selected, executed, deleted, canceled, stored, and changed using the user input means. The item can be used as a concept including a button, an icon (or a shortcut icon), a thumbnail image, and a folder including at least one object in the electronic device 100. The item can be presented in the form of an image, a text, or the like.

The shortcut icon is an image displayed on the touch screen 190 of the electronic device 100 for quick execution of an application or a call, a contact number, a menu, and so forth. Upon input of a command or a selection for executing the shortcut icon, a corresponding application is executed.

The controller 110 senses a user input event, such as a hovering event, when the input unit 168 approaches the touch screen 190 or is disposed in proximity to the touch screen 190.

Upon occurrence of a user input event with respect to a preset item or in a predetermined manner, the controller 110 performs a preset program operation corresponding to the user input event.

The controller 110 outputs a control signal to the input unit 168 or the vibration element 164. The control signal can include information about a vibration pattern, and the input unit 168 or the vibration element 164 generates vibration corresponding to the vibration pattern. The information about the vibration pattern can indicate the vibration pattern and an identifier of the vibration pattern. The control signal can include only a vibration generation request.

The electronic device 100 can include at least one of the mobile communication module 121, the WLAN module 131, and the short-range communication module 132.

The mobile communication module 121 can facilitate the connection between the electronic device 100 and an external device through mobile communication by using one or more antennas (not illustrated) under control of the controller 110. The mobile communication module 121 transmits/receives a wireless signal for a voice call, a video call, a text message (Short Messaging Service: SMS), and/or a multimedia message (Multi Media Service: MMS) with a cellular phone (not illustrated), a smart phone (not illustrated), a tablet PC, or another electronic device (not illustrated) which has a phone number input into the electronic device 100.

The sub communication module 130 includes the WLAN module 131 and the short-range communication module 132. Alternatively, the sub communication module 130 can include either the WLAN module 131 or the short-range communication module 132, or both.

The WLAN module 131 can be connected to the Internet in a place where a wireless AP (not illustrated) is installed, under control of the controller 110. The WLAN module 131 supports the wireless LAN standard IEEE802.11x of the Institute of Electrical and Electronics Engineers (IEEE). The short-range communication module 132 can wirelessly perform short-range communication between the electronic device 100 and an external electronic device under control of the controller 110. The short-range communication can include Bluetooth, infrared data association (IrDA), WiFi-Direct communication, NFC communication, or the like.

Through the sub communication module 130, the controller 110 transmits a control signal corresponding to a vibration pattern to the input unit 168.

The broadcast communication module 141 receives a broadcast signal (for example, a TV broadcast signal, a radio broadcast signal, or a data broadcast signal) and broadcast additional information (for example, Electronic Program Guide (EPG) or Electronic Service Guide (ESG)) transmitted from a broadcasting station (not shown) via a broadcast communication antenna (not illustrated) under control of the controller 110.

The multimedia module 140 includes the audio playback module 142 or the video playback module 143. The audio playback module 142 can play a digital audio file (for example, a file having a file extension such as ‘mp3’, ‘wmat’, ‘ogg’, or ‘way’) stored in the storage unit 175 or received under control of the controller 110. The video playback module 143 can play a digital video file (for example, a file having a file extension such as ‘mpeg’, ‘mpg’, ‘mp4’, ‘avi’, ‘mov’, or ‘inky’) stored or received under control of the controller 110.

The multimedia module 140 can be integrated into the controller 110. The camera module 150 includes the first camera 151 and the second camera 152 which capture a still image or a video under control of the controller 110. The camera module 150 also includes the barrel unit 155 for performing the zoom-in/zoom-out operations for photographing, the motor 154 for controlling motion of the barrel unit 155, and the flash 153 for providing an auxiliary light source necessary for photographing. The first camera 151 can be positioned on the front surface of the electronic device 100, and the second camera 152 can be positioned on the rear surface of the electronic device 100.

The first camera 151 and the second camera 152 each include a lens system, an image sensor, and so forth. The first camera 151 and the second camera 152 convert an optical signal (input or captured) through the lens systems into an electric image signal (or a digital image) and output the electric image signal to the controller 110. The user can capture a moving image or a still image through the first camera 151 and the second camera 152.

The input/output module 160 includes the at least one button 161, the microphone 162, the speaker 163, the vibration element 164, the connector 165, the keypad 166, the earphone connecting jack 167, and the input unit 168. However, it should be noted that the input/output module 160 is not limited to those examples, and a cursor control such as, for example, a mouse, a track ball, a joy stick, or a cursor direction key can be provided to control movement of a cursor on the touch screen 190.

The buttons 161 can be formed on at least one of a front surface, a side surface, and a rear surface of a housing (or case) of the electronic device 100, and can include at least one of a power/lock button, a volume button, a menu button, a home button, a back button, and a search button.

The microphone 162 receives voice or sound and generates a corresponding electric signal under control of the controller 110.

The speaker 163 outputs sound corresponding to various signals or data (for example, wireless data, broadcast data, digital audio data, digital video data, or the like) under control of the controller 110. The speaker 163 can output sound corresponding to a function executed by the electronic device 100 (for example, button manipulation sound corresponding to a phone call, a ring back tone, or voice of a counterpart user). One or more speakers 163 can be formed in a proper position or proper positions of the housing of the electronic device 100.

The vibration element 164 converts an electric signal into mechanical vibration under control of the controller 110. For example, in the electronic device 100, in a vibration mode, if a voice call or a video call from another device (not illustrated) is received, the vibration element 164 operates. One or more of the vibration element 164 can be disposed in the housing of the electronic device 100. The vibration element 164 can operate in response to user input generated through the touch screen 190.

The connector 165 can be used as an interface for connecting the electronic device 100 with an external device (not illustrated) or a power source (not illustrated). Under control of the controller 110, data stored in the storage unit 175 of the electronic device 100 can be transmitted to an external electronic device or data can be received from the external electronic device through a wired cable connected to the connector 165. The electronic device 100 receives power from the power source through the wired cable connected to the connector 165 or can charge a battery (not illustrated) by using the power source.

The keypad 166 receives key input from the user for control of the electronic device 100. The keypad 166 includes a physical keypad (not illustrated) formed in the electronic device 100 or a virtual keypad (not illustrated) displayed on the touch screen 190. The physical keypad (not illustrated) formed in the electronic device 100 can be excluded according to the capability or structure of the electronic device 100.

An earphone (not illustrated) can be inserted into the earphone connecting jack 167 to be connected to the electronic device 100.

The input unit 168 can be inserted into the electronic device 100 for keeping, and when being used, can be withdrawn or separated from the electronic device 100. In a region of an inner side of the electronic device 100 into which the input unit 168 is inserted, an attach/detach recognition switch 169 is disposed to provide a signal corresponding to attachment or detachment of the input unit 168 to the controller 110. The attach/detach recognition switch 169 can be configured to directly or indirectly contact the input unit 168 when the input unit 168 is mounted. Thus, the attach/detach recognition switch 169 generates the signal corresponding to attachment or separation of the input unit 168 (that is, a signal for indicating the attachment or detachment of the input unit 168) based on whether it contacts the input unit 168, and outputs the signal to the controller 110.

The sensor module 170 includes at least one sensor for detecting a state of the electronic device 100. For example, the sensor module 170 can include at least one of a proximity sensor for detecting the user's proximity with respect to the electronic device 100, an illumination sensor (not illustrated) for detecting an amount of light around the electronic device 100, a motion sensor (not illustrated) for detecting an operation of the electronic device 100 (for example, rotation of the electronic device 100 or acceleration or vibration applied to the electronic device 100), a gyroscope for detecting rotational movement of the electronic device 100, an accelerometer for detecting an accelerated movement of the electronic device 100, a geo-magnetic sensor (not illustrated) for detecting a point of the compass by using the Earth's magnetic field, a gravity sensor for detecting a working direction of the gravity, an altimeter for measuring an atmospheric pressure to detect an altitude, and a Global Positioning System (GPS) module 157.

The GPS module 157 receives electric waves from a plurality of GPS satellites (not illustrated) in the Earth's orbit, and calculates a location of the electronic device 100 by using a time of arrival from the GPS satellite (not illustrated) to the electronic device 100.

The storage unit 175 stores a signal or data which is input/output corresponding to operations of the communication module 120, the multimedia module 140, the input/output module 160, the sensor module 170, or the touch screen 190, under control of the controller 110. The storage unit 175 can also store a control program and applications for control of the electronic device 100 and/or the controller 110.

The term “storage unit” includes the storage unit 175, the ROM 112 and the RAM 113 in the controller 110, or a memory card (not illustrated) mounted in the electronic device 100 (for example, a Secure Digital (SD) card, a memory stick). The storage unit 175 can include a non-volatile memory, a volatile memory, a Hard Disk Drive (HDD), or a Solid State Drive (SSD).

The storage unit 175 can also store applications of various functions such as navigation, video communication, games, an alarm application based on time, images for providing a Graphic User Interface (GUI) related to the applications, user information, documents, databases or data related to a method for processing touch inputs, background images (e.g., a menu screen, a standby screen, and so forth), operation programs necessary for driving the electronic device 100, and images captured by the camera module 150.

The storage unit 175 can store a program and related data for executing a method for conversion between audio and a text according to the present disclosure.

The storage unit 175 is a machine, such as, for example, a non-transitory computer-readable medium. The term “machine-readable medium” includes a medium for providing data to the machine to allow the machine to execute a particular function. The storage unit 175 can include non-volatile media or volatile media. Such a medium needs to be of a tangible type so that commands delivered to the medium can be detected by a physical tool which reads the commands with the machine.

The machine-readable medium can include, but is not limited to, at least one of a floppy disk, a flexible disk, a hard disk, a magnetic tape, a Compact Disc Read-Only Memory (CD-ROM), an optical disk, a punch card, a paper tape, a Random Access Memory (RAM), a Programmable Read-Only Memory (PROM), an Erasable PROM (EPROM), and a flash EPROM.

The power supply unit 180 supplies power to one or more batteries disposed in the housing of the electronic device 100 under control of the controller 110. The one or more batteries supply power to the terminal electronic device 100. The power supply unit 180 can also supply power input from an external power source through the wired cable connected with the connector 165 to the electronic device 100. The power supply unit 180 can also supply power, which is wirelessly input from an external power source using a wireless charging technique, to the electronic device 100.

The electronic device 100 includes the touch screens 190 which provide a user graphic interface corresponding to various services (for example, call, data transmission, broadcasting, picture taking) to users.

The touch screen 190 outputs an analog signal, which corresponds to at least one input to the user graphic interface, to the touch screen controller 195.

The touch screen 190 receives at least one user inputs through a user's body (for example, a finger including a thumb) or the input unit 168 (for example, a stylus pen or an electronic pen).

The touch screen 190 also receives a continuous movement of one touch (i.e., a drag input). The touch screen 190 outputs an analog signal corresponding to the received continuous movement of the touch to the touch screen controller 195.

In the present disclosure, a touch can also include a non-contact touch (for example, when the user input means is positioned within a distance of, for example, 1 cm) in which the user input means can be detected without a direct contact with the touch screen 190. The touch can also include a direct contact between the touch screen 190 and a finger or the input unit 168. A distance or interval from the touch screen 190 within which the user input means can be detected can be changed according to the capability or structure of the electronic device 100. In particular, to separately detect a direct touch event based on a contact with the user input means and an indirect touch event (i.e., a hovering event), the touch screen 190 can be configured to output different values for values (for example, an analog voltage value or current value) detected in the direct touch event and the hovering event.

The touch screen 190 can be implemented as, for example, a resistive type, a capacitive type, an infrared type, an acoustic wave type, or a combination thereof.

The touch screen 190 can include at least two touch screen panels capable of sensing a finger input and a pen input, respectively, to distinguish an input made by a first user input means (a human body part such as a finger) (that is, the finger input) from an input made by a second user input means, that is, the input unit 168 (that is, the pen input). A passive type and an active type of a user input means are distinguished according to whether the user input means can create or induce energy such as electric waves or electromagnetic waves and output them. The at least two touch screen panels provide different output values to the touch screen controller 195. Thus, the touch screen controller 195 differently recognizes the values input from the at least two touch screen panels to identify whether the input from the touch screen 190 is the input generated by the finger or by the input unit 168. For example, the touch screen 190 can have a combined structure of a capacitive touch screen panel and an Electromagnetic Resonance (EMR) touch screen panel. As mentioned previously, the touch screen 190 can be configured to have touch keys such as the menu button 161b and the back button 161c, such that the finger input in the present disclosure or the finger input on the touch screen 190 includes the touch input on the touch key.

The touch screen controller 195 converts the analog signal received from the touch screen 190 into a digital signal and transmits the digital signal to the controller 110. The controller 110 controls the touch screen 190 by using the digital signal received from the touch screen controller 195. For example, the controller 110 can control a shortcut icon (not illustrated) displayed on the touch screen 190 to be selected or executed in response to a direct touch event or a hovering event. The touch screen controller 195 can be included in the controller 110.

The touch screen controller 195, by detecting a value (for example, an electric-current value) output through the touch screen 190, recognizes a hovering interval or distance as well as a user input position and converts the recognized distance into a digital signal (for example, a Z coordinate), which it then sends to the controller 110. The touch screen controller 195 can also, by detecting the value output through the touch screen 190, detect a pressure applied by the user input means to the touch screen 190, convert the detected pressure into a digital signal, and provide the digital signal to the controller 110.

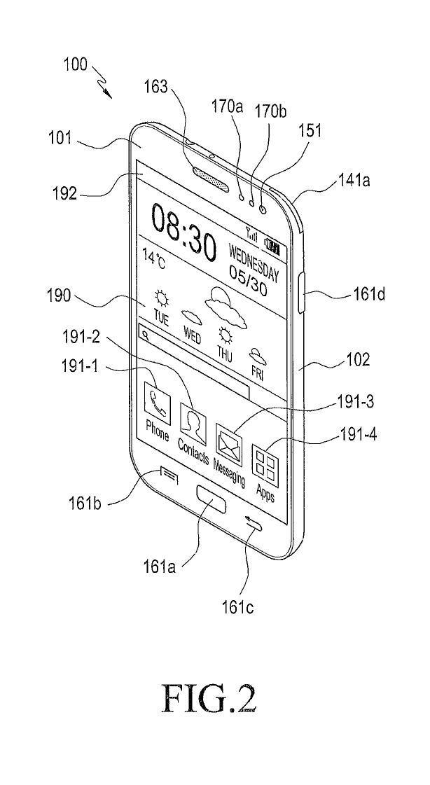

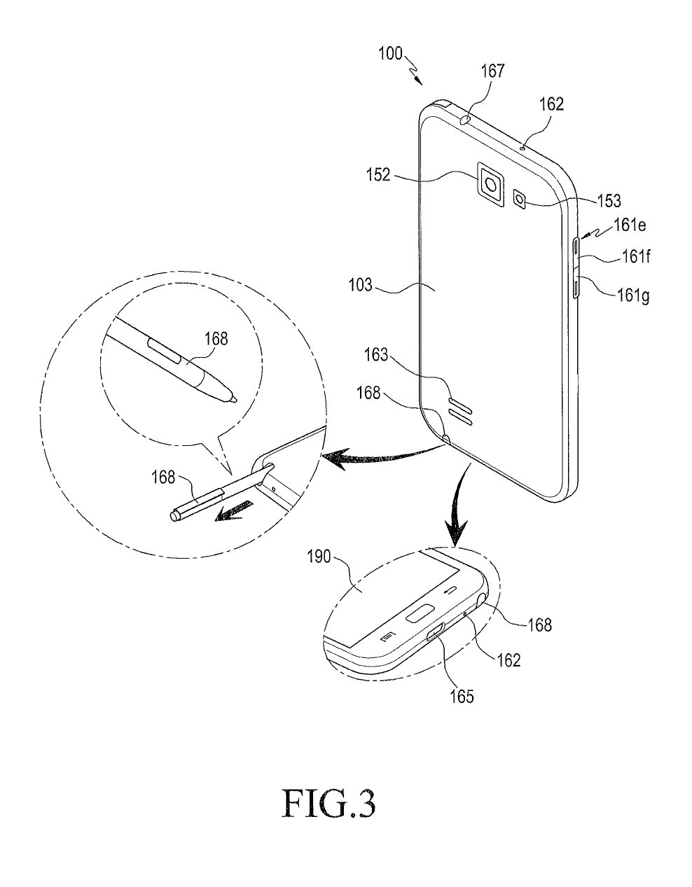

FIG. 2 is a front perspective view of the electronic device 100 according to an embodiment of the present disclosure, and FIG. 3 is a rear perspective view of the electronic device 100 according to an embodiment of the present disclosure. Referring to FIGS. 2 and 3, the touch screen 190 is disposed in the center of a front surface 101 of the electronic device 100. The touch screen 190 can be large enough to occupy most of the front surface 101 of the electronic device 100. FIG. 2 shows an example in which a main home screen is displayed on the touch screen 190. The main home screen is an initial screen displayed on the touch screen 190 when the electronic device 100 is powered on. When the electronic device 100 has different home screens of several pages, the main home screen can be the first home screen among the home screens of the several pages. Shortcut icons 191-1, 191-2, and 191-3 for executing frequently used applications, a main menu change key 191-4, time, weather, and so forth can be displayed on the home screen. If the user selects the main menu change key 191-4, a menu screen is displayed on the touch screen 190. A status bar 192 indicating a state of the electronic device 100, such as a battery charge state, a strength of a received signal, and a current time, can be formed in an upper portion of the touch screen 190.

In a lower portion of the touch screen 190, touch keys, mechanical buttons, or a combination thereof, such as a home button 161a, a menu button 161b, and a back button 161c, can be disposed. These touch keys can be provided as a part of the touch screen 190.

The home button 161a is intended to display the main home screen on the touch screen 190. For example, when any home screen, which is different from the main home screen, or a menu screen is displayed on the touch screen 190, the main home screen can be displayed on the touch screen 190 upon selection of the home button 161a. If the home button 161a is selected during execution of applications on the touch screen 190, the main home screen illustrated in FIG. 2 can be displayed on the touch screen 190. The home button 161a can be used to display recently used applications or a task manager on the touch screen 190.

The menu button 161b provides a connection menu which can be displayed on the touch screen 190. The connection menu can include, for example, a widget add menu, a background change menu, a search menu, an edit menu, and an environment setting menu.

The back button 161c can be used to display a screen which was displayed immediately before the currently executed screen or to terminate the most recently used application.

The first camera 151, an illumination sensor 170a, a proximity sensor 170b, and a first distance/bio sensor can be disposed on an edge of the front surface 101 of the electronic device 100. The second camera 152, the flash 153, the speaker 163, and a second distance/bio sensor can be disposed on a rear surface 103 of the electronic device 100.

A power/lock button 161d, a volume button 161e including a volume-up button 161f and a volume-down button 161g, a terrestrial DMB antenna 141a for broadcasting reception, and one or more microphones 162 can be disposed on a lateral surface 100b of the electronic device 100. The DMB antenna 141a can be fixed to or removable from the electronic device 100.

The connector 165, in which multiple electrodes are formed and can be connected with an external device in a wired manner, can be formed in a lower-end lateral surface of the electronic device 100. The earphone connecting jack 167, into which the earphone can be inserted, can be formed in an upper-end lateral surface of the electronic device 100.

The input unit 168, which can be stored by being inserted into the electronic device 100 and can be withdrawn and separated from the electronic device 100 for use, can be mounted/formed on the lower-end larger surface of the electronic device 100.

The controller 110 controls the overall operation of the electronic device 100, and the controller 110 controls other components in the electronic device 100 to execute a method for conversion between audio and a text according to the present disclosure.

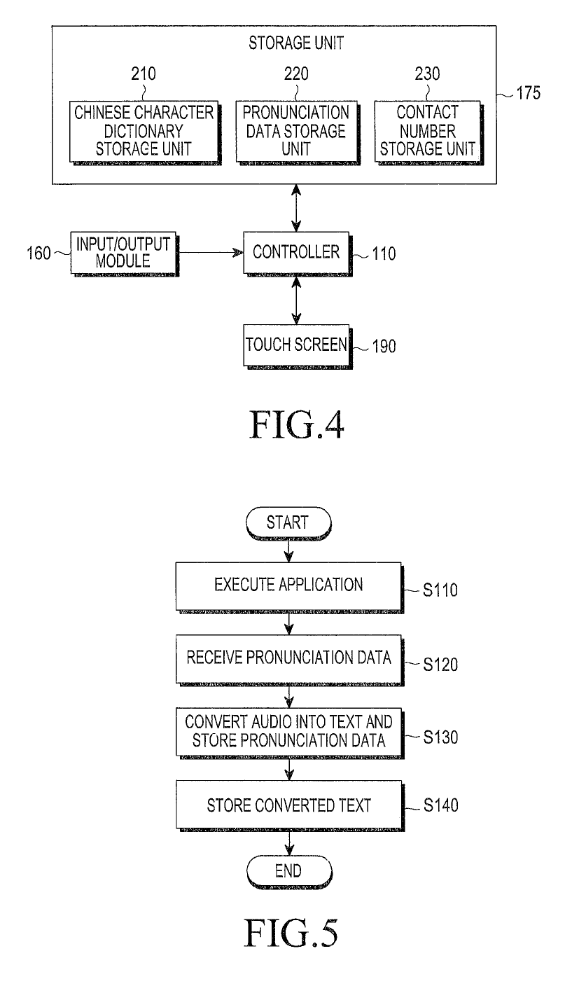

FIG. 4 is a diagram illustrating main components of the electronic device 100 for executing a pronunciation information storing method according to an embodiment of the present disclosure.

The main components of the electronic device 100 include the touch screen 190, the input/output module 160, the storage unit 175, and the controller 110.

The storage unit 175 includes a Chinese character dictionary storage unit 210, a pronunciation data storage unit 220, and a contact number storage unit 230. The pronunciation data storage unit 220 and the contact number storage unit 230 are storage units for storing information input by a user (that is, a user input storage unit), and the Chinese character dictionary storage unit 210 is a storage unit in which information is input in advance, rather than a user input storage unit.

The controller 110 displays a window for inputting pronunciation data on a screen of the touch screen 190. The user inputs pronunciation data (that is, a phonetic sign) through the input/output module 160 or the touch screen 190. The pronunciation data can be displayed as a Roman character, a foreign language (Japanese such as Hiragana or Katakana), a Korean character, a pronunciation notation, or the like.

The controller 110 searches the Chinese character dictionary storage unit 210 of the storage unit 170 to find a text, that is, a Chinese character, matched to the pronunciation data. The controller 110 displays the found Chinese character on the screen of the touch screen 190, and if the user selects the displayed Chinese character, the selected Chinese character is displayed on an input window in place of the pronunciation data. The controller 110 maps the pronunciation data and the selected Chinese character to each other and stores them in the pronunciation data storage unit 220.

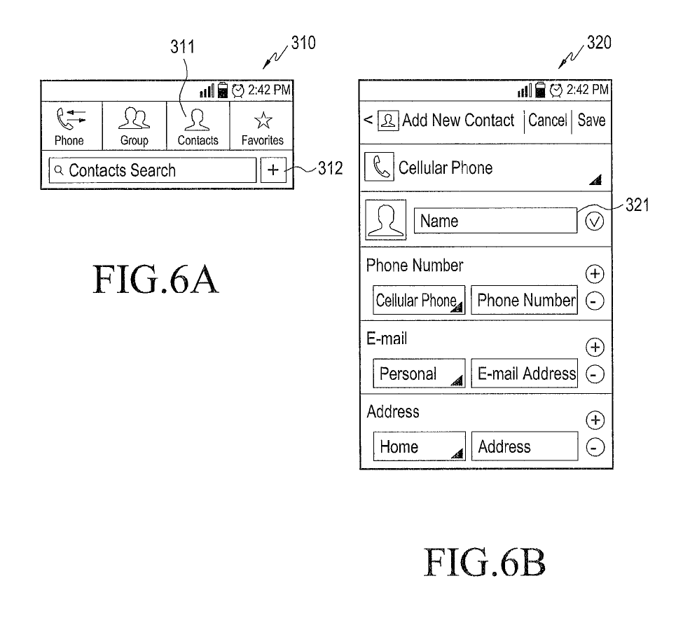

FIG. 5 is a flowchart of a pronunciation information storing method according to an embodiment of the present disclosure, and FIGS. 6 through 9 are views for describing a pronunciation information storing method according to an embodiment of the present disclosure.

The pronunciation information storing method includes steps S110 through S140.

Step S110 is an application execution step in which for example, by touching a desired icon among various icons displayed on the screen of the touch screen 190, the user can execute an application mapped to the icon.

The controller 110 receives a user input through the input/output module 160, the touch screen 190, the camera module 150, or the communication module 120. The user can select the button 161, an icon, or a menu item through the input/output module 160 or the touch screen 190, input a speech command through the microphone 162, perform a gesture or a motion input through the camera module 150, or wirelessly input a particular command through the communication module 120. The command can be an application execution command, and the application can be an arbitrary application, such as a contacts application, a voice recognition application, a schedule management application, a document creation application, a music application, an Internet application, a map application, a camera application, an e-mail application, a picture application, an image editing application, a search application, a file search application, a video application, a game application, a Social Networking Service (SNS) application, a phone application, or a message application. The gesture or motion input refers to an operation in which the user draws a trajectory corresponding to a preset pattern such as a circle, a triangle, a rectangle, or the like. In the current example, the application is executed according to user input, but the application can also be automatically executed upon occurrence of an event such as message reception, call reception, or occurrence of an alarm event.

FIG. 6A illustrates a touch screen 310 on which a contacts application 311 is executed. Once the user selects a new contacts addition button 312, a new contacts addition screen 320 is displayed as illustrated in FIG. 6B.

Step S120 is a pronunciation reception step in which the controller 110 receives pronunciation data from the user. Referring to FIG. 6B, the user can input a name to a name input window 321 of the new contacts addition screen 320.

Step S130 is a text conversion and pronunciation data storing step in which the controller 110 searches the Chinese character dictionary storage unit 210 of the storage unit 175 to find a text matched to the pronunciation data, that is, a Chinese character. The controller 110 displays at least one candidate text based on the found Chinese character.

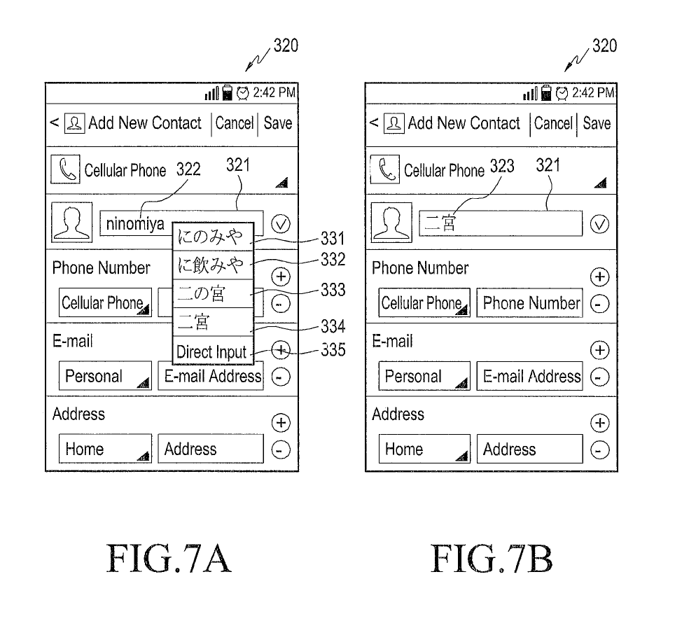

Referring to FIG. 7A, if the user inputs “ninomiya” 322 in the name input window 321, the controller 110 searches the Chinese character dictionary storage unit 210 to find a Chinese character “ [symbol] ” corresponding to “nomi”, Chinese characters “ [symbol] ” corresponding to “ninomiya”, and Chinese characters “ [symbol] ” and “ [symbol] ” corresponding to “ni” and “miya”. The controller 110 displays candidate texts “ [symbol] ” 331, “ [symbol] ” 332, “ [symbol] ” 333, and “ [symbol] ” 334.

Referring to FIG. 7B, if the user selects the candidate text “ [symbol] ” 334, the controller 110 displays the Chinese characters “ [symbol] ” 323 in place of the input pronunciation “ninomiya”. The controller 110 also maps the input pronunciation “ninomiya” and the Chinese character “ [symbol] ” 323 to each other and stores them in the pronunciation data storage unit 220.

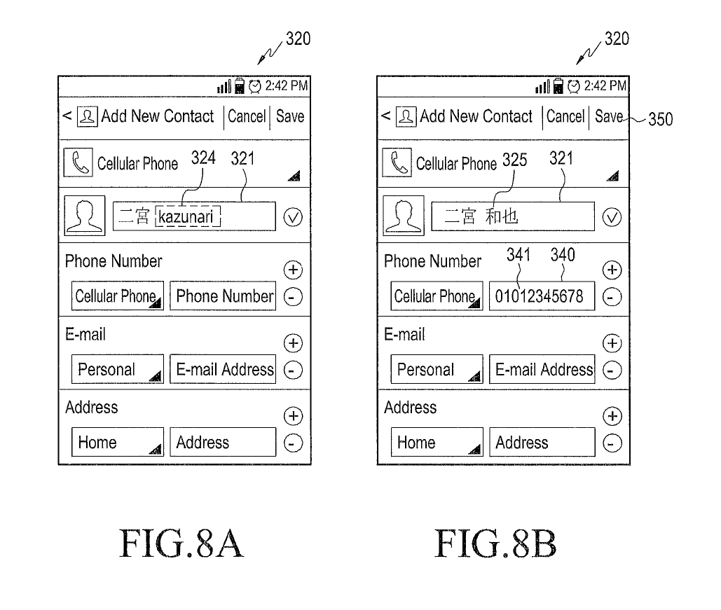

Referring to FIG. 8A, the user inputs “kazunari” 324 in succession to “ [symbol] ” in the name input window 321 to input the first name after the last name “ninomiya”.

Referring to FIG. 8B, in the same manner as described above regarding “ninomiya”, the controller 110 displays Chinese characters “ [symbol] ” 325 in place of the input pronunciation “kazunari” on the name input window 321 according to user's selection. The controller 110 also maps the pronunciation “kazunari” and the Chinese characters “ [symbol] ” to each other and stores them in the pronunciation data storage unit 220.

Step S140 is a step for storing the converted text, in which the user inputs a phone number “01012345678” 341 of“ [symbol] ” in a phone number input window 340 and presses a save (or storing) button 350 to store a contact number of “ [symbol] ” in the storage unit 175. The storage unit 175 includes the contact number storage unit 230 in which the contact number of “ [symbol] [symbol] ” can be stored.

In the current example, a text is a Chinese character and pronunciation data is a Roman character, but the present disclosure can also be applied to other situations in which a notation character and a pronunciation character are different from each other. For example, a text can be a Chinese character or a Russian character, and pronunciation data can be a Roman character (that is, an alphabet), Hiragana, Katakana, or a Korean character.

In the current example, in every Chinese character conversion, pronunciation data and a Chinese character are stored in the pronunciation data storage unit 220, but the pronunciation data and the Chinese character can be stored in the pronunciation data storage unit 220 after completion of Chinese character conversion of a full name. For example, completion of Chinese character conversion can be determined as user's selection of another input window or of the save button 350.

In the current example, for a full pronunciation “ninomiya kazunari”, the controller 110 maps an input pronunciation “ninomiya” and Chinese characters “ [symbol] ” to each other and stores the mapped input pronunciation and Chinese character, and then maps an input pronunciation “kazunari” and Chinese characters “ [symbol] ” to each other and stores the mapped input pronunciation and Chinese character in the pronunciation data storage unit 220.

According to a first example shown in Table 1, the pronunciation data storage unit 220 can store plural pronunciation information in the form of a plurality of records.

TABLE 1

| Record No. | Chinese Character | Pronunciation | . . . |
|---|---|---|---|
| Al | [symbol] | ninomiya | . . . |
| A2 | [symbol] | kazunari | . . . |
| . . . | . . . | . . . | . . . |
| An | Bn | Cn | . . . |

Each record Ai(1≦i≦n, n is an integer greater than 1) can include information such as a Chinese character field Bi or a pronunciation field Ci.

On the other hand, after mapping the pronunciation data “ninomiya” and the Chinese characters “ [symbol] ” to each other and storing them in the pronunciation data storage unit 220, the controller 110 can add the pronunciation data “kazunari” to the pronunciation data “ninomiya” and the Chinese characters “ [symbol] ” to the Chinese characters “ [symbol] ” and store them.

The controller 110 can also map the pronunciation data “ninomiya kazunari” and the Chinese characters “ [symbol] ” and store them in the pronunciation data storage unit 220.

Table 2 shows a second example of the pronunciation data storage unit 220.

TABLE 2

| Record No. | Chinese Character | Pronunciation | . . . |
|---|---|---|---|
| Al | [symbol] | ninomiya kazunari | . . . |
| A2 | B2 | C2 | . . . |
| . . . | . . . | . . . | . . . |
| An | Bn | Cn | . . . |

Alternately, the pronunciation data storage unit 220 can include the records A1 and A2 of the first example and the record A1 of the second example.

As shown in Table 3, the Chinese character dictionary storage unit 210 can store plural Chinese character information in the form of a plurality of records.

TABLE 3

| Record No. | Chinese Character | Pronunciation 1 | Pronunciation 2 | . . . |
|---|---|---|---|---|
| Al | [symbol] | kazuya | kazunari | . . . |
| A2 | [symbol] | hikaru | hikari | . . . |
| . . . | . . . | . . . | . . . | . . . |
| An | Bn | Cn | Dn | . . . |

Each record Ai can include information such as a Chinese character field Bi, a first pronunciation field Ci, and a second pronunciation field Di.

As shown in Table 4, the contact number storage unit 230 can also store plural contact number information in the form of a plurality of records.

TABLE 4

| Record No. | Name | Phone Number | . . . |
|---|---|---|---|
| Al | [symbol] | 01012345678 | . . . |
| A2 | B2 | C2 | . . . |
| . . . | . . . | . . . | . . . |
| An | Bn | Cn | . . . |

Each record Ai can include information such as a name field Bi and a phone number field Ci.

Unlike the foregoing examples, the pronunciation data storage unit 220 can be integrated into the contact number storage unit 230 as shown in Table 5.

TABLE 5

| Record No. | Name | Phone Number | Pronunciation | . . . |
|---|---|---|---|---|
| Al | [symbol] | 01012345678 | ninomiya kazunari | . . . |
| A2 | B2 | C2 | D2 | . . . |
| . . . | . . . | . . . | . . . | . . . |
| An | Bn | Cn | Dn | . . . |

For example, after completion of Chinese character conversion, if the user selects another input window rather than the name input window 321 or selects the save button 350, then the controller 110 can automatically store pronunciation data in the contact number storage unit 230.

Referring back to FIG. 7A, if the user selects a direct input item 335 instead of candidate texts 331 through 334, the user can directly input the Chinese characters “ [symbol] ” 323 in place of the pronunciation data “ninomiya” 322. Also in this case, the controller 110 maps the input pronunciation “ninomiya” and the Chinese characters “ [symbol] ” to each other and store them in the pronunciation data storage unit 220. For example, the user can search for Chinese characters corresponding to the input pronunciation “ninomiya” by using an application capable of searching for Chinese characters such as an Internet application or a dictionary application, copy the found Chinese characters, and paste them to the name input window 321. If the user selects the direct input item 335, the user can be automatically connected to such an application capable of searching for Chinese characters.

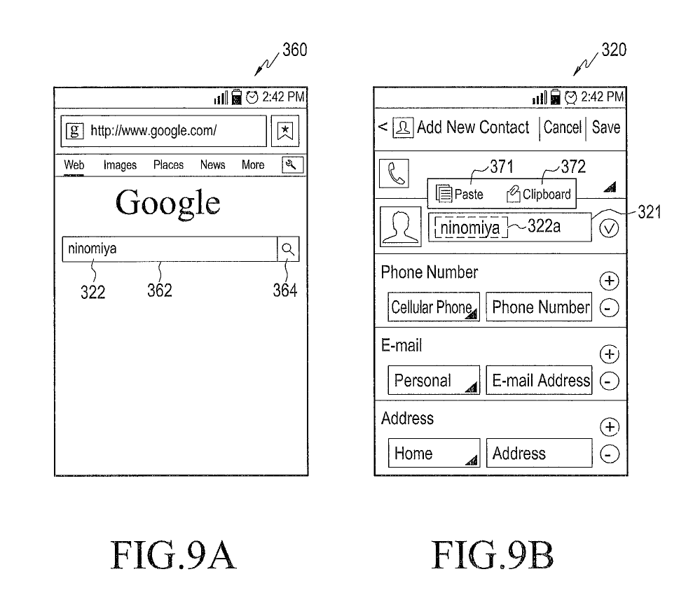

Referring to FIG. 9A, the user inputs “ninomiya” 322 to a search window 362 of an Internet application screen 360 and selects a search button 364 to search for Chinese characters corresponding to the pronunciation data “ninomiya”. The user can also copy the found Chinese characters “ [symbol] ”.

Referring to FIG. 9B, the user selects “ninomiya” 322a on the name input window 321 and replaces the selected “ninomiya” 322a with the found Chinese characters “ [symbol] ” by using a paste item 371 or a clipboard item 372. The screen on which “ [symbol] ” is displayed in place of “ninomiya” is illustrated in FIG. 7B. The controller 110 maps the pronunciation data “ninomiya” and the Chinese characters “ [symbol] ” to each other and stores them in the pronunciation data storage unit 220.

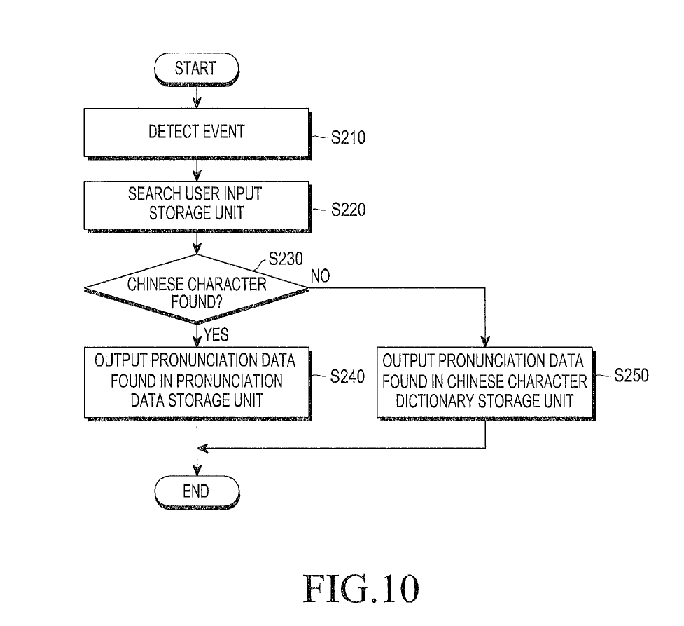

FIG. 10 is a flowchart illustrating a method for conversion between audio and text according to a first embodiment of the present disclosure.

Step S210 is an event detection or identification step in which the controller 110 detects or identifies an event (or a request) for requesting output of a text as audio, such as text message reception, call reception, or a document/character string reading command. Such an event is an arbitrary event in which conversion of a text into audio is set.

Step S220 is a user input storage unit search step in which if the identified event is text message reception or call message reception (or call reception), the controller 110 extracts a phone number from a text message or a call message and searches for the extracted phone number in the contact number storage unit 230. If a name mapped to the phone number found in the contact number storage unit 230 includes a Chinese character, the controller 110 searches for the Chinese character in the pronunciation data storage unit 220.

If the detected event is a document/character string reading command, the controller 110 searches in the pronunciation data storage unit 220 for a Chinese character included in a document or a character string.

Step S230 is a search confirmation step in which the controller 110 performs step S240 if pronunciation data corresponding to Chinese characters is found in the pronunciation data storage unit 220; otherwise, if the pronunciation data is not found in the pronunciation data storage unit 220, the controller 110 performs step S250.

Step S240 is a step of outputting the pronunciation data found in the pronunciation data storage unit 220, in which the controller 110 outputs the pronunciation data found in the pronunciation data storage unit 220 as audio.

Step S250 is a step of outputting pronunciation data found in the Chinese character dictionary storage unit 210, in which the controller 110 searches for Chinese characters in the Chinese character dictionary storage unit 210, and outputs a pronunciation found in the Chinese character dictionary storage unit 210. If a plurality of pronunciations mapped to the Chinese characters are found in the Chinese character dictionary storage unit 210, the controller 110 outputs a pronunciation suitable for a context among the plurality of pronunciations, or outputs a representative pronunciation among the plurality of pronunciations.

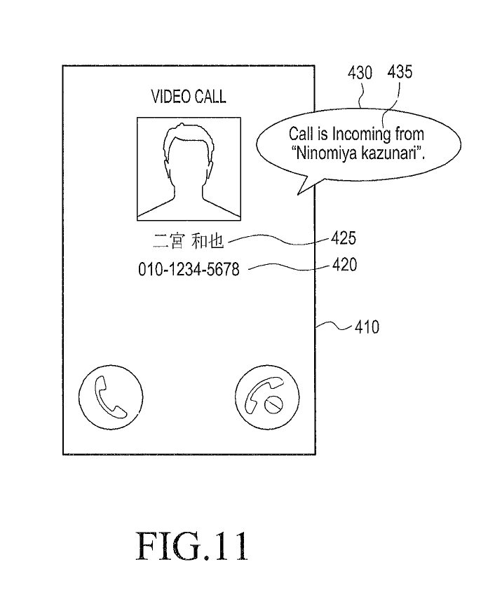

FIG. 11 is a diagram for describing a method for conversion between audio and text according to the first embodiment of the present disclosure. FIG. 11 illustrates a call incoming screen 410, and the controller 110 displays a caller's phone number 420 extracted from a call message and a caller's name 425 found in the contact number storage unit 230 on the call incoming screen 410. The controller 110 synthesizes pronunciation data “Ninomiya kazunari” 435 found in the pronunciation data storage unit 220 with a preset guide comment 430 (that is, call is incoming from “ . . . ”) and outputs them as audio.

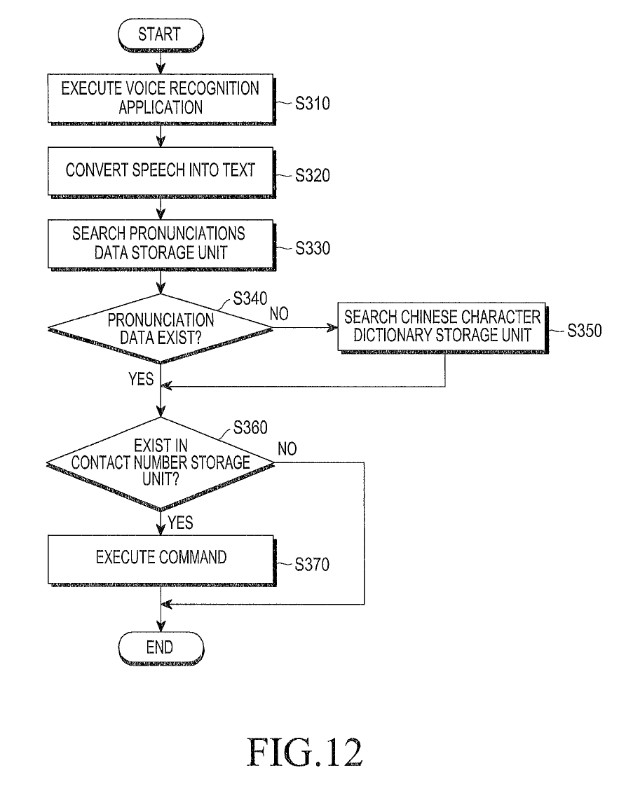

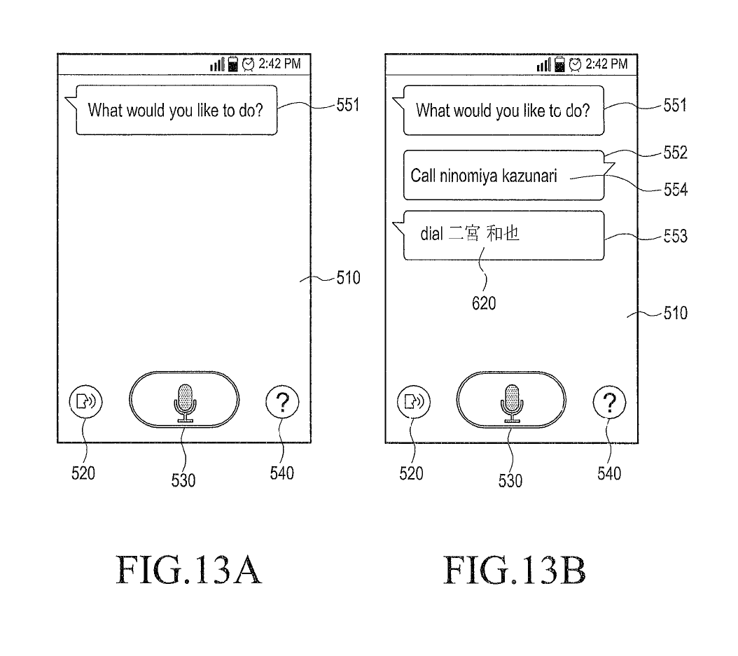

FIG. 12 is a flowchart of a method for conversion between audio and text according to a second embodiment of the present disclosure, and FIGS. 13A and 13B are diagrams for describing a method for conversion between audio and text according to the second embodiment of the present disclosure.

Step S310 is a step of executing a voice recognition application in which the user executes a voice recognition application by performing selection of a button, an icon, or a menu item, input of a speech command, a gesture, or a motion, or input of a touch pattern through the touch screen 190, the input/output module 160, or the camera module 150.

For example, the user can execute the voice recognition application by double-clicking a home button 161a.

FIG. 13A illustrates a voice recognition application screen 510.

Once the voice recognition application is initially driven, a user guide phrase 551, such as “What would you like to do?”, is displayed on an application screen 510.

In a lower portion of the application screen 510, a voice guide button 520 which guides a use method in the form of voice when being clicked, a voice recognition button 530 which executes a voice recognition mode when being clicked, and a help button 540 which displays examples of a use method when being clicked are provided.

Step S320 is a speech-to-text conversion step in which the controller 110 converts user's speech into a text.

For example, the user can input a speech command “Call Ninomiya kazunari” and the controller 110 converts user's speech into a text.

Step S330 is a pronunciation data storage unit search step in which the controller 110 extracts pronunciation data “Ninomiya kazunari” from the converted text and searches in the pronunciation data storage unit 220 for the pronunciation data.

Step S340 is a search confirmation step in which the controller 110 performs 5360 if the pronunciation data is found in the pronunciation data storage unit 220; otherwise, if the pronunciation data is not found in the pronunciation data storage unit 220, the controller 110 performs step S350.

Step S350 is a Chinese character dictionary storage unit search step in which the controller 110 searches in the Chinese character dictionary storage unit 210 for the pronunciation data.

Step S360 is a contact number storage unit search step in which the controller 110 searches in the contact number storage unit 230 for a text (that is “ [symbol] ”) mapped to the pronunciation data found in the pronunciation data storage unit 220 or a text mapped to the pronunciation data found in the Chinese character dictionary storage unit 210. The controller 110 performs step S370 if the text mapped to the pronunciation data is found in the contact number storage unit 230; otherwise, if the text mapped to the pronunciation data is not found in the contact number storage unit 230, the controller 110 terminates this method.

Step S370 is a command execution step in which the controller 110 dials “ [symbol] [symbol] ” by using a phone number mapped to the text “ [symbol] t”.

Referring to FIG. 13B, the controller 110 displays a result 552 of converting a user's speech command “Call Ninomiya kazunari” into a text and a text 553 indicating an operation to be executed (that is, “Dial [symbol] ”) on the application screen 510. The converted text 552 includes pronunciation data “Ninomiya kazunari” 554, and the text 553 indicating the operation to be executed includes a text “ [symbol] ” 620 mapped to the pronunciation data.

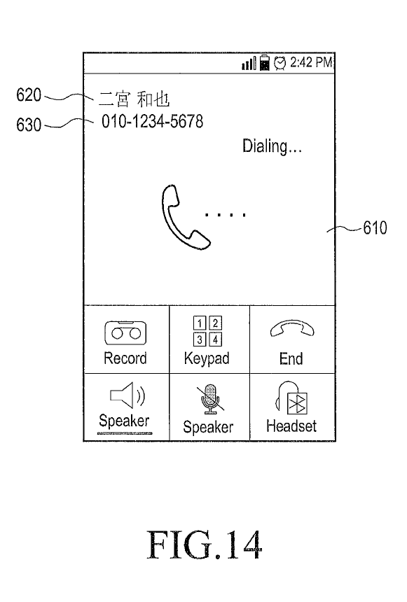

FIG. 14 illustrates a calling screen 610 in which the controller 110 displays a phone number 630 and a name 620 found in the pronunciation data storage unit 220 and/or the contact number storage unit 230 on the calling screen 610.

Unlike in the current example, the controller 110 can display a text indicating that the command cannot be executed (for example, “A contact number of [symbol] is not found”) on the application screen 510, if the text mapped to the pronunciation data is not found in the contact number storage unit 230.

In the foregoing examples, a touch screen is used as a representative example of a display unit for displaying a screen, but a general display unit having no touch sensing function, such as a Liquid Crystal Display (LCD), Organic Light Emitting Diodes (OLED), or LED, can be used in place of a touch screen.

According to the present disclosure, a method is provided in which when a text is converted into audio or audio is converted into a text, a text which can have a plurality of pronunciations can be accurately pronounced according to a user's intention, or a text can be accurately searched for based on a pronunciation corresponding to a user's intention.

Moreover, according to the present disclosure, a method is also provided for accurately pronouncing or recognizing a Japanese Kanji, especially, a Chinese character related to a proper noun.

Furthermore, according to the present disclosure, by using pronunciation data such as Hiragana or a Roman character used in Chinese character input without an additional request to a user, an electronic device can accurately predict Chinese character pronunciation the user knows.

It can be seen that the embodiments of the present disclosure can be implemented with hardware, software, or a combination of hardware and software. Such arbitrary software can be stored, whether or not erasable or re-recordable, in a volatile or non-volatile storage such as a Read-Only Memory (ROM); a memory such as a Random Access Memory (RAM), a memory chip, a device, or an integrated circuit; and an optically or magnetically recordable and machine (e.g., computer)-readable storage medium such as a Compact Disc (CD), a Digital Versatile Disk (DVD), a magnetic disk, or a magnetic tape. It can be seen that a storage unit included in an electronic device is an example of a machine-readable storage medium which is suitable for storing a program or programs including instructions for implementing the embodiments of the present disclosure. Therefore, the present disclosure includes a program including codes for implementing an apparatus or method claimed in an arbitrary claim and a machine-readable storage medium for storing such a program. The program can be electronically transferred through an arbitrary medium such as a communication signal delivered through wired or wireless connection, and the present disclosure properly includes equivalents thereof.

The electronic device may receive and store the program from a program providing device connected in a wired or wireless manner. The program providing device may include a memory for storing a program including instructions for instructing the electronic device to execute the preset method for conversion between audio and a text, a communication module for performing wired or wireless communication with the electronic device, and a controller for transmitting a corresponding program to the electronic device at the request of the electronic device or automatically.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for converting a text into audio, the method comprising:
detecting a request for outputting a text as audio;
searching for the text in a user input storage unit;
searching for pronunciation data corresponding to the found text in the user input storage unit; and
outputting an audio signal corresponding to the found pronunciation data.

2. The method of claim 1, further comprising:
searching for the pronunciation data corresponding to the text in a preset dictionary storage unit, if the pronunciation data corresponding to the text is not found in the user input storage unit; and
outputting the pronunciation data found in the dictionary storage unit as audio.

3. The method of claim 1, wherein the text is a Chinese character string.

4. The method of claim 1, wherein the request for outputting the text as audio is generated upon reception of a message, and the user input storage unit comprises at least one of a contact number storage unit and a pronunciation data storage unit.

5. The method of claim 4, wherein the searching for pronunciation data corresponding to the found text in the user input storage unit comprises:
extracting a phone number from the message; and
searching in the user input storage unit for the pronunciation data corresponding to the text mapped to the extracted phone number.

6. The method of claim 4, wherein the searching for pronunciation data corresponding to the found text in the user input storage unit comprises:
extracting a phone number from the message;
searching in the contact number storage unit for the text mapped to the extracted phone number; and
searching in the pronunciation data storage unit for the pronunciation data corresponding to the text found in the contact number storage unit.

7. The method of claim 1, further comprising, before detecting the request for outputting a text as audio:
receiving the pronunciation data from a user;
converting the pronunciation data into the text; and
automatically storing the pronunciation data and the text in the user input storage unit.

8. The method of claim 7, further comprising, before receiving the pronunciation data from the user:
displaying a window for inputting the pronunciation data on a screen of a display unit.

9. The method of claim 8, further comprising displaying at least one text matched to the pronunciation data on the screen of the display unit,
wherein the pronunciation data is converted into a text selected by the user from among the at least one text.

10. The method of claim 8, wherein the window for inputting the pronunciation data is provided through a contact number application.

11. The method of claim 10, wherein the pronunciation data and the text are mapped to each other and stored in a pronunciation data storage unit, and the text is stored in the contact number storage unit, together with a contact number.

12. The method of claim 1, further comprising:
displaying a plurality of candidate texts regarding the pronunciation data on a screen; and
replacing the pronunciation data with a candidate text selected by the user from among the plurality of candidate texts, and displaying the replaced candidate text to the user.

13. A machine-readable recording medium having recorded thereon a program that when executed, causes a processing circuitry to:
detect a request for outputting a text as audio;
search for the text in a user input storage unit;
search for pronunciation data corresponding to the found text in the user input storage unit; and
output an audio signal corresponding to the found pronunciation data.

14. An electronic device for converting a text into audio, the electronic device comprising:
a storage unit comprising a user input storage unit; and
a controller configured to identify an event that requires output of a text as audio,
search for pronunciation data corresponding to the text in the user input storage unit, and
output the pronunciation data found in the user input storage unit as audio if the pronunciation data corresponding to the text exists in the user input storage unit.

15. The electronic device of claim 14, wherein the controller is configured to search for the pronunciation data corresponding to the text in a preset dictionary storage unit if the pronunciation data corresponding to the text does not exist in the user input storage unit, and output the pronunciation data found in the dictionary storage unit as audio.

16. The electronic device of claim 14, wherein the text is a Chinese character string.

17. An electronic device for converting audio into a text, the electronic device comprising:
a storage unit comprising a user input storage unit; and
a controller configured to convert audio into pronunciation data, searching for a text mapped to the pronunciation data in the user input storage unit, and output the text found in the user input storage unit if the text exists in the user input storage unit.

18. The electronic device of claim 17, wherein the controller is configured to execute a user's command indicated by the audio.

19. The electronic device of claim 18, wherein the user's command is a command for sending a call message or a text message, and the user input storage unit comprises at least one of a contact number storage unit and a pronunciation data storage unit.
